(19) United States
(12) Patent Application Publication
(10) Pub. No.: US 2023/0318028 A1
(43) Pub. Date: Oct. 5, 2023

(54) SOLID-STATE SECONDARY BATTERY AND METHOD OF MANUFACTURING SOLID-STATE SECONDARY BATTERY

(71) Applicant: HONDA MOTOR CO., LTD., Tokyo (JP)

(72) Inventors: Akihiro YOSHIZAWA, Saitama (JP); Wataru SHIMIZU, Saitama (JP)

(21) Appl. No.: 18/189,230

(22) Filed: Mar. 24, 2023

(30) Foreign Application Priority Data
Mar. 29, 2022 (JP) 2022-053058

(51) Int. Cl. H01M 10/0562; H01M 4/36; H01M 10/0525

(52) U.S. Cl. CPC H01M 10/0562; H01M 4/366; H01M 10/0525

(57) ABSTRACT

To provide a solid-state secondary battery that is superior in output characteristics and durability characteristics, and with which preferable durability is acquired. A solid-state secondary battery includes a negative electrode layer, a positive electrode layer, and a solid electrolyte layer. The solid electrolyte layer contains a binding material. The binding material is contained in a greater amount on a side closer to the negative electrode layer and a side closer to the positive electrode layer than sides closer to the center in thickness directions in the solid electrolyte layer.

This application is based on and claims the benefit of priority from Japanese Patent Application No. 2022-053058, filed on 29 Mar. 2022, the content of which is incorporated herein by reference.

### BACKGROUND OF THE INVENTION

### Field of the Invention

The present invention relates to a solid-state secondary battery and a method of manufacturing a solid-state secondary battery.

### Related Art

Conventionally, secondary batteries such as lithium ion secondary batteries having high energy density have been widely used. In recent years, secondary batteries have been considered for use in various applications including on-vehicle purposes in terms of improving energy efficiency, of mitigating adverse effects to the global environment by increasing the ratio of renewable energy, and of reducing CO₂. A secondary battery has a structure where a solid electrolyte (a separator) exists between a positive electrode and a negative electrode, and the battery is filled with a liquid or solid electrolyte (an electrolytic solution).

Compared with a secondary battery using an electrolytic solution, a solid-state secondary battery using a solid electrolyte is thermally safe, making it possible to respond to demands of more compact features. A solid-state secondary battery is formed by performing, when electrode layers and a solid electrolyte layer are produced, mixing with a binding material (a binder) to make a slurry mixture and performing coating with the slurry mixture. For example, Japanese Patent No. 6498335 discloses, as a method of manufacturing a solid electrolyte sheet, a technology including coating an adhesive agent onto a surface of a frame surrounding voids of a porous substrate and filling an inorganic solid electrolyte material into the voids.

Patent Document 1: Japanese Patent No. 6498335

### SUMMARY OF THE INVENTION

In the technology described in Japanese Patent No. 6498335, there is an issue that the adhesive agent (a binding material) coated on the surface of the solid electrolyte inhibits conduction of lithium ions, sacrificing the output characteristics and the durability characteristics of the solid-state secondary battery. Furthermore, the presence of the adhesive agent (the binding material) inside the solid electrolyte layer causes grain boundaries to occur, which may cause cracks, lowering the durability.

In view of the issues described above, an object of the present invention is to provide a solid-state secondary battery that is superior in output characteristics and durability characteristics, and with which preferable durability is acquired.

(1) The present invention relates to a solid-state secondary battery including a negative electrode layer, a positive electrode layer, and a solid electrolyte layer. The solid electrolyte layer contains a binding material. The binding material is contained in a greater amount on a side closer to the negative electrode layer and a side closer to the positive electrode layer than sides closer to the center in thickness directions in the solid electrolyte layer.

According to the present invention as described in (1), it is possible to provide a solid-state secondary battery that is superior in output characteristics and durability characteristics, and with which preferable durability is acquired.

(2) The solid-state secondary battery described in (1), in which the solid electrolyte layer is provided with binding-material-free regions where the binding material is not contained on the sides closer to the center in the thickness directions.

According to the present invention as described in (2), it is possible to preferably suppress reductions in conductivity of charge transferring media due to the binding material and the occurrence of cracks in the solid electrolyte layer.

(3) The solid-state secondary battery described in (1) or (2), in which the solid electrolyte layer includes: a first layer that is a layer closer to the side closer to the negative electrode layer or the side closer to the positive electrode layer in the solid electrolyte layer; and a second layer that is a layer closer to each of the sides closer to the center in the thickness directions in the solid electrolyte layer, and a contained amount of the binding material in the first layer is greater than a contained amount of the binding material in the second layer, and a contained amount of the binding material in at least either of the first layer and the second layer varies in such a manner that the contained amount of the binding material increases toward the side closer to the negative electrode layer or the side closer to the positive electrode layer.

According to the present invention as described in (3), it is possible to preferably satisfy both bondability between each of electrode layers and a solid electrolyte layer and the conductivity of the charge transferring media.

(4) Furthermore, the present invention relates to a method of manufacturing a solid-state secondary battery including electrode layers and a solid electrolyte layer. The method of manufacturing a solid-state secondary battery includes coating an electrode composite material containing a binding material onto the solid electrolyte layer that do not contain the binding material.

According to the present invention as described in (4), it is possible to easily manufacture a solid-state secondary battery containing a binding material in a greater amount on sides closer to electrode layers than sides closer to the center in the thickness directions in the solid electrolyte layer.

(5) The method of manufacturing a solid-state secondary battery, described in (4), in which the coating is performed using dip coating.

According to the present invention as described in (5), it is possible to easily manufacture a solid-state secondary battery containing a binding material in a greater amount on sides closer to electrode layers than sides closer to the center in the thickness directions in the solid electrolyte layer.

### BRIEF DESCRIPTION OF THE DRAWINGS

FIG. 1 is a cross-sectional view illustrating a configuration of a solid-state secondary battery according to an embodiment of the present invention;

FIG. 2 is a graph illustrating an abundance ratio of a binding material (a binder) in FIG. 1;

FIG. 3 is a cross-sectional view illustrating a configuration of a conventional solid-state secondary battery;

FIG. 4A is a graph illustrating output characteristics of solid-state secondary batteries according to an example of the present invention and a comparative example;

FIG. 4B is a graph illustrating durability characteristics of the solid-state secondary batteries according to the example of the present invention and the comparative example;

FIG. 5A is a graph illustrating binder abundance ratios on sides closer to positive electrodes of the solid-state secondary batteries according to the example of the present invention and the comparative example; and

FIG. 5B is a graph illustrating binder abundance ratios on sides closer to negative electrodes of the solid-state secondary batteries according to the example of the present invention and the comparative example.

### DETAILED DESCRIPTION OF THE INVENTION

### Solid-state Secondary Battery

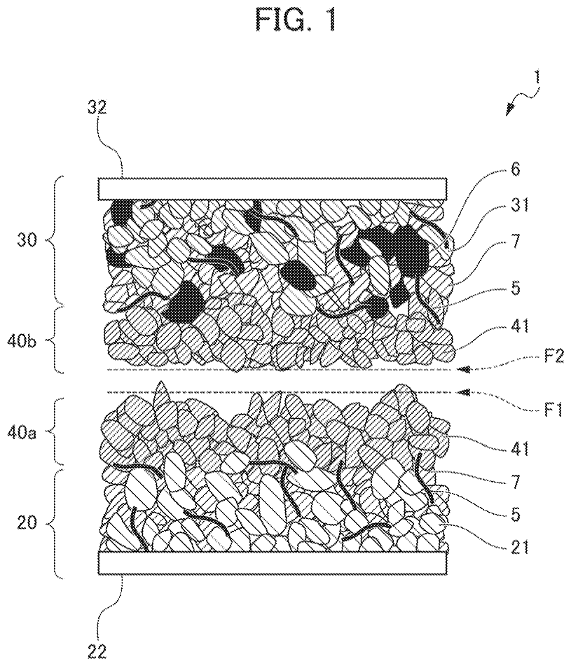

A solid-state secondary battery 1 according to an embodiment of the present invention will now be described herein. The solid-state secondary battery 1 according to the present embodiment is produced, as illustrated in FIG. 1, by laminating a negative electrode layer 20 serving as an electrode layer, solid electrolyte layers 40a and 40b, and a positive electrode layer 30 serving as an electrode layer with each other in this order. The solid-state secondary battery 1 is, for example, a lithium ion solid-state secondary battery using lithium ions as charge transferring media. The solid-state secondary battery 1 will be described below as such a lithium ion solid-state secondary battery.

### Negative Electrode Layer

The negative electrode layer 20 is produced, for example, by forming a negative electrode composite material layer on a negative electrode current collector 22. The negative electrode composite material layer contains, as illustrated in FIG. 1, a negative electrode active material 21, a binder 5, a conductive auxiliary agent 6, and a solid electrolyte 7.

The negative electrode active material 21 is not particularly limited. It is possible to apply a material that is known to be used as a negative electrode active material for a solid-state secondary battery. Example materials to be used as the negative electrode active material 21 include lithium transition metal oxides such as lithium titanate (Li₄Ti₅O₁₂), transition metal oxides such as TiO₂, Nb₂O₃, and WO₃, metallic sulfides, metallic nitrides, carbon materials such as graphite, soft carbon, and hard carbon, metallic lithium, metallic indium, and lithium alloys.

The negative electrode current collector 22 is not particularly limited. It is possible to apply a material that is known to be used as a negative electrode current collector for a solid-state secondary battery. Example materials to be used as the negative electrode current collector 22 include copper and stainless steel. As for an example material such as copper or stainless steel as described above, one that is formed into a piece of foil is used.

The binder 5 serving as a binding material is contained, together with the negative electrode active material 21, in a negative electrode composite material in the form of a slurry used when applying the negative electrode composite material onto the negative electrode current collector 22. Thereby, it is possible to improve bondability between the negative electrode composite material layer and the negative electrode current collector 22 and between the negative electrode composite material layer and the solid electrolyte layer 40a. Furthermore, it is possible to increase the negative electrode layer 20 in film thickness to increase the amount of the negative electrode active material 21 per unit area. On the other hand, since the binder 5 serves as a resistance element when the solid-state secondary battery 1 operates, the more the additive amount of the binder 5, the higher the internal resistance in the battery and the lower the output of the battery. It is possible that the contained amount of the binder 5 in the negative electrode composite material layer ranges from 0.1 wt % to 2.0 wt % with respect to the whole mass of the negative electrode composite material layer.

As for the binder 5, it is possible to use a binder that is known to be used for a solid-state secondary battery. Example materials to be used as the binder include nitrile-based polymers, polyester-based polymers, acrylic acid-based polymers, cellulose-based polymers, styrene-based polymers, styrene butadiene-based polymers, vinyl acetate-based polymers, urethane-based polymers, and fluoroethylene-based polymers.

As for the conductive auxiliary agent 6, it is possible to use a conductive auxiliary agent that is known to be used for a solid-state secondary battery. Example materials to be used as the conductive auxiliary agent 6 include acetylene black, natural graphite, artificial graphite, carbon nanotubes (CNT), and carbon nanofibers. Note that the negative electrode layer 20 may not contain the conductive auxiliary agent 6.

As for the solid electrolyte 7, it is possible to use a similar or identical material to a solid electrolyte 41 contained in the solid electrolyte layers, described later.

### Positive Electrode Layer

The positive electrode layer 30 is produced, for example, by forming a positive electrode composite material layer on a positive electrode current collector 32. The positive electrode composite material layer contains, as illustrated in FIG. 1, a positive electrode active material 31, the binder 5, the solid electrolyte 7, and the conductive auxiliary agent.

The positive electrode active material 31 is not particularly limited. It is possible to use a material that is known to be used as a positive electrode active material for a solid-state secondary battery. Example materials to be used as the positive electrode active material 31 include layered positive electrode active material particles such as LiCoO₂, LiNiO₂, LiCoₓNi_{y}Mn_{z}O₂ (x+y+z=1), LiVO₂, and LiCrO₂, spinel type positive electrode active materials such as LiMn₂O₄, Li(Ni_{0.25}Mn_{0.75})₂O₄, LiCoMnO₄, and Li₂NiMn₃O₈, olivine type positive electrode active materials such as LiCoPO₄, LiMnPO₄, and LiFePO₄, solid solution oxides (Li₂MnO₃—LiMO₂ (M=Co, Ni, etc.)), electro conductive polymers such as polyaniline and polypyrrole, sulfides such as Li₂S, CuS, Li—Cu—S compounds, TiS₂, FeS, MoS₂, and Li—Mo—S compounds, and mixtures of sulfur and carbon. The positive electrode active material described above may contain one of the materials described above or may have a composition containing two or more of the materials described above.

The positive electrode current collector 32 is not particularly limited. It is possible to apply a material that is known to be used as a positive electrode current collector for a solid-state secondary battery. Example materials to be used as the positive electrode current collector 32 include aluminum and stainless steel. As for an example material such as aluminum or stainless steel as described above, one that is formed into a piece of foil is used. Instead of the materials described above, a conductive carbon sheet (for example, a graphite sheet or a CNT sheet) may be used, for example.

As for the binder 5, the solid electrolyte 7, and the conductive auxiliary agent contained in the positive electrode composite material layer in the positive electrode layer 30, it is possible to apply a similar configuration to the configuration in the negative electrode composite material layer described above.

### Solid Electrolyte Layer

The solid electrolyte layers 40a and 40b each contain the solid electrolyte 41 and the binder 5. FIG. 1 illustrates a state of the solid electrolyte layer 40a formed on the negative electrode layer 20 and the solid electrolyte layer 40b formed on the positive electrode layer 30. The solid-state secondary battery 1 is acquired by laminating and bonding, through pressing, a surface F1 of the solid electrolyte layer 40a and a surface F2 of the solid electrolyte layer 40b with each other. That is, the surfaces F1 and F2 described above are surfaces disposed on sides closer to a center in thickness directions in the whole of the solid electrolyte layers.

The solid electrolyte 41 is not particularly limited, as long as it is able to conduct lithium ions. It is possible to apply a material that is known to be used as a solid electrolyte used for a solid-state secondary battery. Example materials to be used as the solid electrolyte 41 include sulfide-based solid electrolytes, oxide-based solid electrolytes, nitride-based solid electrolytes, and halide-based solid electrolytes.

The solid electrolyte layers 40a and 40b contain the binder 5. As for the binder 5, it is possible to use a binder that is similar or identical in type to those contained in the negative electrode layer 20 and the positive electrode layer 30 described above. In the solid-state secondary battery according to the present embodiment, it is possible that a contained amount of the binder 5 is lower than conventional ones. For example, it is possible that each of the contained amounts of the binder 5 in the solid electrolyte layers 40a and 40b is equal to or below 3 wt % with respect to the whole mass of each of the solid electrolyte layers 40a and 40b.

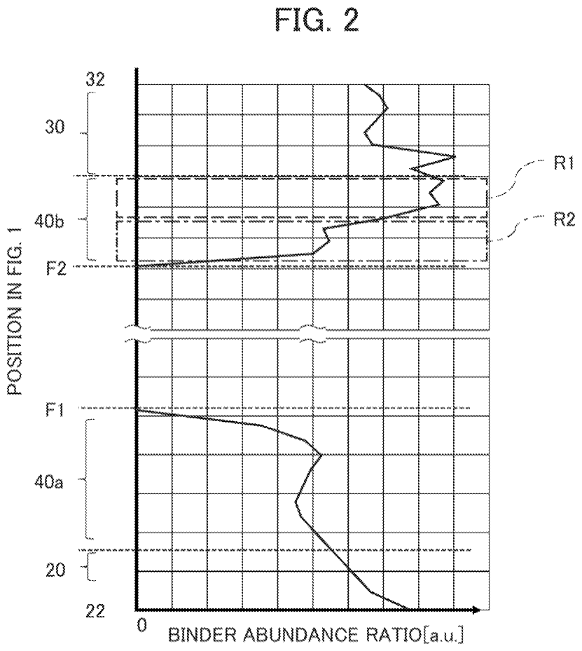

FIG. 2 schematically illustrates an abundance ratio X pertaining to the contained amount of the binder 5 in the solid-state secondary battery 1. The vertical axis in FIG. 2 corresponds to FIG. 1, and indicates a position in laminate thickness directions in the solid-state secondary battery 1. The horizontal axis in FIG. 2 indicates the binder abundance ratio X, illustrating that the closer to the right side in FIG. 2, the higher the binder abundance ratio X.

As illustrated in FIG. 2, the abundance ratio X of the binder 5 is highest in each of the negative electrode layer 20 and the positive electrode layer 30, presenting a substantially constant abundance ratio. Thereby, bondability is secured between the negative electrode layer 20 and the solid electrolyte layer 40a and between the positive electrode layer 30 and the solid electrolyte layer 40b. On the other hand, in the solid electrolyte layers 40a and 40b, the closer from the negative electrode layer 20 and the positive electrode layer 30 toward the surfaces F1 and F2, the lower the abundance ratio X of the binder 5. That is, the abundance ratio X of the binder 5 is lowest on the sides closer to the center in the thickness directions in the solid electrolyte layers 40a and 40b. Thereby, it is possible to reduce the occurrence of grain boundaries in the solid electrolyte layers, suppressing the occurrence of cracks in the solid electrolyte layers. In addition to the feature described above, it is also possible to reduce the total amount of the binder 5 contained in the solid electrolyte layers. Therefore, it is possible to improve the output characteristics and the cycle durability of the solid-state secondary battery 1.

As illustrated in FIG. 2, the solid electrolyte layer 40b includes a first layer R1 that is a layer closer to the side closer to the positive electrode layer 30 and a second layer R2 that is a layer closer to the side closer to the center in the thickness directions in the solid electrolyte layer 40b. The abundance ratio of the binder 5 in the first layer R1 is higher than the abundance ratio of the binder 5 in the second layer R2. Furthermore, the closer to the side closer to the positive electrode layer 30, the higher the abundance ratio of the binder 5 in the second layer R2. With a method of manufacturing a solid-state secondary battery, described later, it is possible to form a solid electrolyte layer including a layer such as the second layer R2 in which the closer to the side closer to an electrode layer, the higher the abundance ratio of the binder 5. Note that the first layer R1 that is a layer closer to the side closer to the positive electrode layer 30 may be such a layer in which the closer to the side closer to the electrode layer, the higher the abundance ratio of the binder 5.

The abundance ratio X of the binder 5 in FIG. 2 illustrates a mere example. For example, the binder abundance ratios X on the surfaces F1 and F2 may be zero. That is, binding-material-free regions where the binder 5 is not present may be provided respectively on the sides closer to the center in the thickness directions in the solid electrolyte layers 40a and 40b. Thereby, it is possible to acquire effects of more preferably suppressing the occurrence of cracks, as described above.

### Method of Manufacturing Solid-state Secondary Battery

A method of manufacturing a solid-state secondary battery, according to the present embodiment, includes coating an electrode composite material containing the binder 5 as a binding material onto solid electrolyte layers that do not contain the binder 5 as a binding material. Thereby, the binder 5 contained in the electrode composite material in the form of a slurry gradually permeates from respective surfaces on the sides, which lie closer to electrode layers, of solid electrolyte layers toward the sides, which lie closer to the center, of the solid electrolyte layers. Therefore, it is possible to form solid electrolyte layers each including a layer (the first layer R1 or the second layer R2) in which the closer to the side closer to an electrode layer, the higher the abundance ratio of the binder 5, to achieve such a state that the abundance ratio of the binder 5 is lowest on the side, which lies closer to the center, in each of the solid electrolyte layers.

It is preferable that the method of coating the electrode composite material described above onto the solid electrolyte layers described above is a method using dip coating.

The method of manufacturing a solid-state secondary battery, according to the present embodiment, for example, includes: forming the solid electrolyte layer 40a by coating a solid electrolyte slurry containing a solid electrolyte that does not contain the binder 5 onto the negative electrode layer 20 including a negative electrode composite material layer containing the negative electrode active material 21, the binder 5, and other materials, and the negative electrode current collector 22; similarly, forming the solid electrolyte layer 40b by coating a solid electrolyte slurry containing a solid electrolyte that does not contain the binder 5 onto the positive electrode layer 30 including a positive electrode composite material layer containing the positive electrode active material 31, the binder 5, and other materials, and the positive electrode current collector 32; and causing the surface F1 of a layered body of the negative electrode layer 20 described above and the solid electrolyte layer 40a and the surface F2 of a layered body of the positive electrode layer 30 described above and the solid electrolyte layer 40b to abut and bond to each other by applying predetermined pressure and a predetermined temperature. Note that it is not always necessarily possible that an interface between the surface F1 and the surface F2 of the solid-state secondary battery manufactured with the manufacturing method described above is clearly identified.

The method of manufacturing a solid-state secondary battery described above is a mere example. The method of manufacturing a solid-state secondary battery may include coating a negative electrode composite material slurry and a positive electrode composite material slurry respectively onto the solid electrolyte layer 40a and the solid electrolyte layer 40b each formed into a layer. The method may otherwise include: coating, using a single solid electrolyte layer, a negative electrode composite material slurry onto a surface side of the solid electrolyte layer described above; coating a positive electrode composite material slurry onto another surface side of the solid electrolyte layer described above; and bonding current collectors respectively onto the electrode composite material layers formed described above.

### Solid-state Secondary Battery according to Prior Art

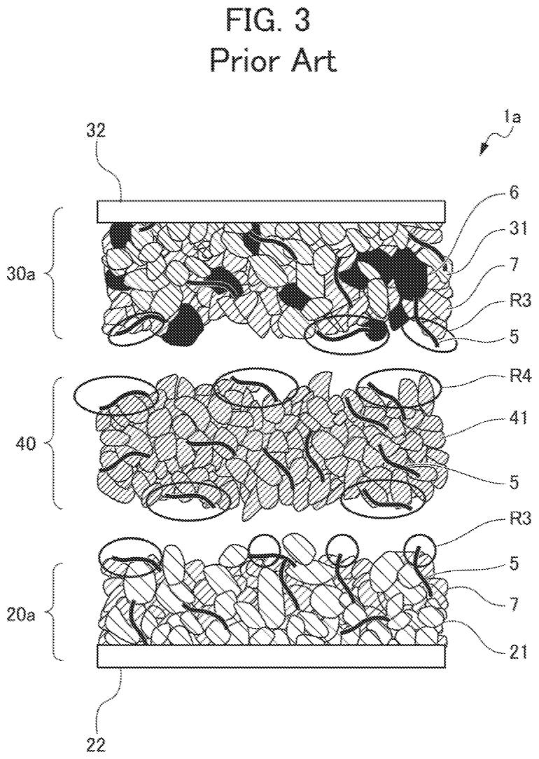

FIG. 3 is a cross-sectional view illustrating a configuration of a solid-state secondary battery 1a according to prior art. In the below descriptions, like reference numerals in FIG. 3 designate similar or identical configurations to those in FIG. 1, and their descriptions may be omitted.

A negative electrode layer 20a, a positive electrode layer 30a, and a solid electrolyte layer 40 in the solid-state secondary battery 1a contain the binder 5 to secure bondability between each two of the layers. Since the layers described above are respectively bonded to each other after the slurry is cured, the binder 5 is evenly distributed in the layers described above. In such a configuration as described above, regions R3 where the binder 5 is present on surfaces of the negative electrode layer 20a and the positive electrode layer 30a are formed. Similarly, regions R4 where the binder 5 is present on surfaces of the solid electrolyte layer 40 are formed.

Since, in the regions R3 and the regions R4 described above, the surfaces of the solid electrolyte 7 and the solid electrolyte 41 are coated with the binder 5, the conduction of lithium ions is inhibited between the negative electrode layer 20a and the positive electrode layer 30a and the solid electrolyte layer 40, resulting in decreases in the output characteristics and the durability characteristics of the solid-state secondary battery 1a. Furthermore, since the surface of the solid electrolyte 41 is coated with the binder 5 in the solid electrolyte layer 40, the conduction of lithium ions is inhibited in the solid electrolyte layer 40. Furthermore, grain boundaries occur in the solid electrolyte layer 40, easily leading to cracks.

On the other hand, the solid-state secondary battery 1 according to the present embodiment is configured to contain, between each of the electrode layers and each of the solid electrolyte layers, the binder 5 at an amount necessary for securing bondability between each two of the layers, and to contain the binder 5 at a smaller contained amount on the sides closer to the center in the thickness directions in the solid electrolyte layers. Thereby, it is possible to secure bondability between each two of the layers, to improve the conductivity of lithium ions, and to suppress the occurrence of cracks in the solid electrolyte layers 40.

The preferable embodiment of the present invention has been described above. The present invention is not limited to the embodiment described above. It is possible to appropriately make modifications without departing from the scope of the present invention.

It has been described that, in the embodiment described above, the contained amount of the binder 5 in each of solid electrolyte layers varies in such a manner that the contained amount of the binding material increases from the side closer to the center in the thickness directions in each of the solid electrolyte layers toward the side closer to one electrode layer. The contained amount of the binder 5 in each of solid electrolyte layers may vary continuously or gradually in such a manner that the contained amount of the binding material increases from the side closer to the center in the thickness directions in each of the solid electrolyte layers toward the side closer to one electrode layer.

### EXAMPLES

The present invention will now be described in more detail with reference to examples. The present invention is not limited by these examples.

### Example

A sulfide-based solid electrolyte was used as a solid electrolyte. Graphite was used as a negative electrode active material. A piece of SUS foil was used as a negative electrode current collector. LiCoₓNi_{y}Mn_{z}O₂ (x+y+z=1) was used as a positive electrode active material. A piece of Al (aluminum) foil was used as a positive electrode current collector. A styrene-butadiene-rubber (SBR)-based binder was used as a binder. The contained amount of the binder in the negative electrode composite material layer was set to 1.0 wt % with respect to the whole mass of the negative electrode composite material layer. After the negative electrode layer and the positive electrode layer were formed, a solid electrolyte slurry where the contained amount of the binder was 0 wt % was applied onto the negative electrode layer and the positive electrode layer respectively to form solid electrolyte layers. After that, the solid electrolyte layers were bonded to each other to produce a solid-state secondary battery according to the example.

### Comparative Example

Excluding that the contained amount of the binder in the solid electrolyte slurry was set to 3 wt %, a solid-state secondary battery according to a comparative example was produced similarly to the example.

### Measuring Binder Abundance Ratios

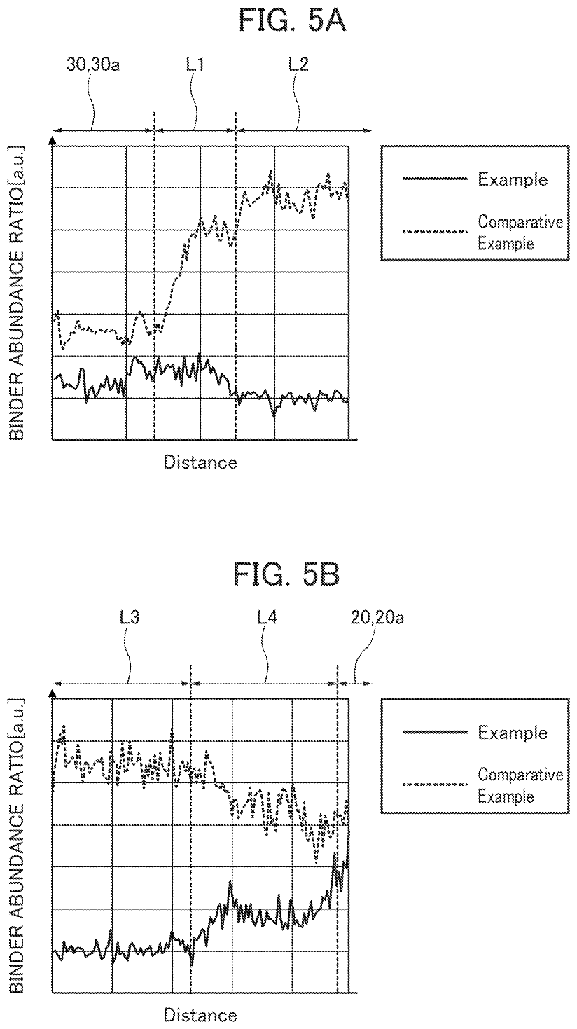

TOF-SIMS TOFSIMS.5 manufactured by IONTOF was used to measure the abundance ratios of the binders in the thickness directions in the solid-state secondary batteries according to the example and the comparative example. The results are as illustrated in FIGS. 5A and 5B. FIG. 5A is a graph of the observations from the positive electrodes 30, 30a. FIG. 5B is a graph of the observations from the negative electrodes 20, 20a. In FIGS. 5A and 5B, the vertical axes indicate the binder abundance ratios. It is indicated that the higher the position in FIGS. 5A and 5B, the higher the binder abundance ratio. In FIGS. 5A and 5B, the horizontal axes indicate distances in the thickness directions in the solid-state secondary batteries. In FIG. 5A, “30, 30a” refer to the positive electrode layers, “L1” refers to the layer closer to the side closer to the positive electrode layer in the solid electrolyte layer, and “L2” refers to the layer closer to the side closer to the center in the thickness directions in the solid electrolyte layer. In FIG. 5B, “20, 20a” refer to the negative electrode layer, “L3” refers to the layer closer to the side closer to the center in the thickness directions in the solid electrolyte layer, and “L4” refers to the layer closer to the side closer to the negative electrode layer in the solid electrolyte layer.

As illustrated in FIGS. 5A and 5B, it was confirmed that, in the solid-state secondary battery according to the example, the amount of the binder was greater on the side closer to the negative electrode layer and the side closer to the positive electrode layer than the sides closer to the center in the thickness directions in the solid electrolyte layers. On the other hand, it was confirmed that, in the solid-state secondary battery according to the comparative example, the amount of the binder was greater on the sides closer to the center in the thickness directions in the solid electrolyte layers than the side closer to the negative electrode layer and the side closer to the positive electrode layer.

### Evaluating Output Characteristics

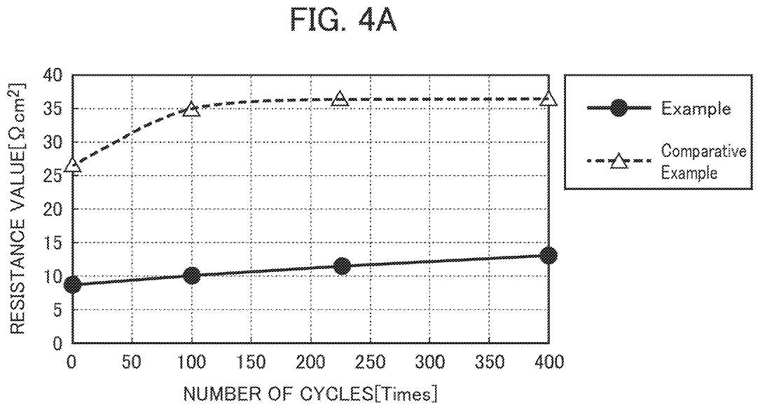

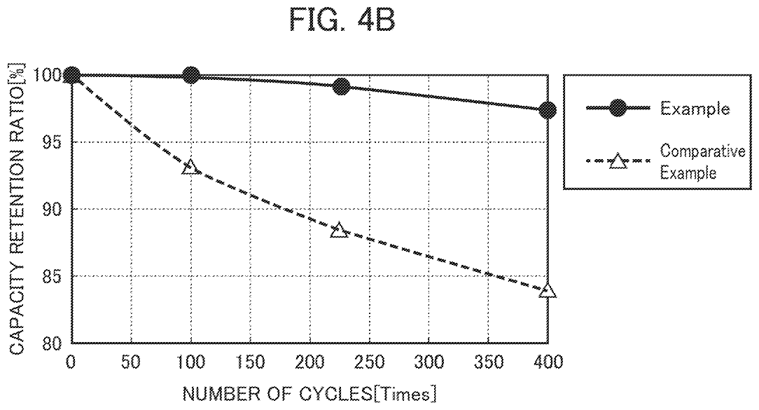

The solid-state secondary batteries according to the example and the comparative example were used to repeat charging and discharging 400 cycles to measure resistance values (Ωcm²) to evaluate the output characteristics of the solid-state secondary batteries. The results are as illustrated in FIG. 4A.

### Evaluating Durability Characteristics

The solid-state secondary batteries according to the example and the comparative example were used to repeat charging and discharging 400 cycles to measure capacity retention ratios (%) to evaluate the durability characteristics of the solid-state secondary batteries. The results are as illustrated in FIG. 4B.

According to the results illustrated in FIGS. 4A and 4B, it was confirmed that the solid-state secondary battery according to the example was superior in the output characteristics and the durability characteristics, compared with the solid-state secondary battery according to the comparative example.

### EXPLANATION OF REFERENCE NUMERALS

1 Solid-state secondary battery
20 Negative electrode layer
30 Positive electrode layer
40a, 40b Solid electrolyte layer
5 Binder (binding material)

What is claimed is:

1. A solid-state secondary battery comprising:
a negative electrode layer;
a positive electrode layer; and a solid electrolyte layer,
the solid electrolyte layer containing a binding material,
the binding material being contained in a greater amount on a side closer to the negative electrode layer and a side closer to the positive electrode layer than sides closer to a center in thickness directions in the solid electrolyte layer.

2. The solid-state secondary battery according to claim 1, wherein the solid electrolyte layer is provided with binding-material-free regions where the binding material is not contained on the sides closer to the center in the thickness directions.

3. The solid-state secondary battery according to claim 1, wherein the solid electrolyte layer includes:
a first layer that is a layer closer to the side closer to the negative electrode layer or the side closer to the positive electrode layer in the solid electrolyte layer; and
a second layer that is a layer closer to each of the sides closer to the center in the thickness directions in the solid electrolyte layer, and
a contained amount of the binding material in the first layer is greater than a contained amount of the binding material in the second layer, and
a contained amount of the binding material in at least either of the first layer and the second layer varies in such a manner that the contained amount of the binding material increases toward the side closer to the negative electrode layer or the side closer to the positive electrode layer.

4. A method of manufacturing a solid-state secondary battery including electrode layers and a solid electrolyte layer, the method comprising
coating an electrode composite material containing a binding material onto the solid electrolyte layer that does not contain the binding material.

5. The method of manufacturing a solid-state secondary battery, according to claim 4, wherein the coating is performed using dip coating.
